(19) United States
(12) Patent Application Publication
(10) Pub. No.: US 2020/0305643 A1
(43) Pub. Date: Oct. 1, 2020

(54) MULTI-SENSOR INTERACTIVE COOKING DEVICE

(71) Applicant: Jerry L. Rodriguez, Orlando, FL (US)

(72) Inventor: Jerry L. Rodriguez, Orlando, FL (US)

(21) Appl. No.: 16/706,703

(22) Filed: Dec. 7, 2019

Related U.S. Application Data
(60) Provisional application No. 62/823,890, filed on Mar. 26, 2019.

(51) Int. Cl. A47J 37/10; A47J 27/00; G01G 19/56

(52) U.S. Cl. CPC A47J 37/108; A47J 27/002; A47J 2203/00; A47J 2202/00; G01G 19/56

(57) ABSTRACT

A multi-sensor interactive cooking device is disclosed herein. In one embodiment the device may comprise a cooking device, such as a pan or pot, integrating a plurality of sensors, a visual display, and an electronic interface. The device may have sensors for measuring, for example, food weight, food temperature, and food volume. The various sensors may be installed within or on the device as appropriate to the form factor of the particular cooking device. By way of example, a cooking device with a longer handle may have a plurality of sensors installed within the carrying handle. A device having shorter handles may have the plurality of sensors installed within its base. The multi-sensor interactive cooking device may further integrate a wireless connectivity and a proprietary software for additional functionality.

### TECHNICAL FIELD OF THE INVENTION

The present invention relates in general to cooking devices, and, more specifically, to a multi-sensor interactive cooking device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Cooking is the practice of preparing food for consumption, and the techniques used in cooking vary widely based on cultural and personal preferences. Cooking may be done almost anywhere, such as in the home, in a restaurant kitchen, or even outdoors, so long as a heat source is available. Such a heat source may be any appropriate source such as an electric or gas stove, microwave, oven, or open fire. The materials being cooked, whether meats, fruits and vegetables, water, or any other items, are often kept separate from the heat source through the use of various cooking devices.

A pan, frying pan, or skillet, for example, is a cooking device that is generally flat-bottomed and having relatively low sides that flare outwards. Pans are generally equipped with a relatively long handle for control, and are often used without a lid, though a sauté pan may incorporate a lid for lower-heat cooking methods. The length of the handle allows for more active control of the pan, and some versions may incorporate a second grip opposite the handle for additional control.

A pot or stock pot, as another example, is a cooking device that is generally flat-bottomed and having straight, relatively high sides. Pots often have two grip handles that may be used to lift or tilt the device, and are better suited to preparing liquid-based dishes such as soups, stocks, or broths. Because pots tend to be larger and contain more volume than pans they are not actively handled during the cooking process and, thus, do not require a longer control handle.

Various other types of cooking devices are in common usage, varying in their diameters, the flare and height of their sides, and their types and number of handles based on the style of cooking to be implemented. Such various devices include, for example, griddles, brasing pans, woks, sauce pans, pie pans, and casserole pots.

The practice of cooking often involves the preparing and combining of multiple elements to form a desired dish, and such elements are generally combined according to a recipe calling for particular amounts or volumes of each element. To improve the accuracy of such added amounts, various measuring devices, such as measuring spoons, measuring cups, and measuring scales, are used to portion out the elements. Measuring devices may also be used during the cooking process to determine portion size for the purpose of tracking calorie intake.

Measuring devices, though, are always implemented separately from cooking devices. A measuring scale, for example, may be an analog or digital device upon which an item may be placed to determine its weight, but which may not be heat resistant enough to withstand the heat of cooking. An issue arises, though, when less than all of the item being measured is transferred to the cooking device, or when the cooking of the item being measured changes its weight or volume.

Thus, there is a need in the art for a multi-sensor interactive cooking device that can measure the weight or volume of food and cooking elements directly within the cooking device, so as to increase the accuracy of the measured elements and track changes in the element's measurements. It is to these ends that the present invention has been developed.

### BRIEF SUMMARY OF THE INVENTION

To minimize the limitations in the prior art, and to minimize other limitations that will be apparent upon reading and understanding the present specification, the present invention describes a multi-sensor interactive cooking device.

It is an objective of the present invention to provide a multi-sensor interactive cooking device that may comprise a cooking device.

It is another objective of the present invention to provide a multi-sensor interactive cooking device that may comprise a pan.

It is another objective of the present invention to provide a multi-sensor interactive cooking device that may comprise a pot.

It is another objective of the present invention to provide a multi-sensor interactive cooking device that may comprise a wok.

It is another objective of the present invention to provide a multi-sensor interactive cooking device that may comprise a plurality of sensors.

It is another objective of the present invention to provide a multi-sensor interactive cooking device that may comprise a weight sensor.

It is another objective of the present invention to provide a multi-sensor interactive cooking device that may comprise a temperature sensor.

It is another objective of the present invention to provide a multi-sensor interactive cooking device that may comprise a volume sensor.

It is another objective of the present invention to provide a multi-sensor interactive cooking device that may comprise a power source.

It is another objective of the present invention to provide a multi-sensor interactive cooking device that may comprise a microcontroller.

It is another objective of the present invention to provide a multi-sensor interactive cooking device that may comprise a universal serial bus (USB) interface.

It is another objective of the present invention to provide a multi-sensor interactive cooking device that may comprise a Teflon layer.

It is another objective of the present invention to provide a multi-sensor interactive cooking device that may comprise a heat resistant layer.

It is another objective of the present invention to provide a multi-sensor interactive cooking device that may comprise a protective cover.

It is another objective of the present invention to provide a multi-sensor interactive cooking device that may comprise a computing device.

It is another objective of the present invention to provide a multi-sensor interactive cooking device that may comprise an electronic interface.

It is another objective of the present invention to provide a multi-sensor interactive cooking device that may comprise a display device.

It is another objective of the present invention to provide a multi-sensor interactive cooking device that may comprise a manual input device.

It is another objective of the present invention to provide a multi-sensor interactive cooking device that may comprise wireless connectivity.

It is another objective of the present invention to provide a multi-sensor interactive cooking device that may comprise a proprietary software application.

It is another objective of the present invention to provide a multi-sensor interactive cooking device that may comprise voice recognition technology.

It is another objective of the present invention to provide a multi-sensor interactive cooking device that may comprise a resilient material of construction.

It is another objective of the present invention to provide a multi-sensor interactive cooking device that may comprise an antimicrobial layer.

It is another objective of the present invention to provide a multi-sensor interactive cooking device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a front isometric perspective view of a first embodiment of a multi-sensor interactive cooking device, as contemplated by the present disclosure;

FIG. 2 illustrates a left side elevation view of a first embodiment of a multi-sensor interactive cooking device, as contemplated by the present disclosure;

FIG. 3 illustrates a top plan view of a first embodiment of a multi-sensor interactive cooking device, as contemplated by the present disclosure;

FIG. 4 illustrates a detailed view of a control handle of a first embodiment of a multi-sensor interactive cooking device, as contemplated by the present disclosure;

FIG. 5 illustrates a detailed view of a sensor base of a first embodiment of a multi-sensor interactive cooking device, as contemplated by the present disclosure;

FIG. 6 illustrates a top plan view of a second embodiment of a multi-sensor interactive cooking device, as contemplated by the present disclosure;

FIG. 7 illustrates a left side elevation view of a second embodiment of a multi-sensor interactive cooking device, as contemplated by the present disclosure;

FIG. 8 illustrates an internal view of a control handle of a second embodiment of a multi-sensor interactive cooking device, as contemplated by the present disclosure;

FIG. 9 illustrates a control handle of a second embodiment of a multi-sensor interactive cooking device, as contemplated by the present disclosure;

FIG. 10 illustrates a control handle heat sink of a second embodiment of a multi-sensor interactive cooking device, as contemplated by the present disclosure; and

FIG. 11 schematically presents a computing system configured to carry out and actualize methods and tasks described herein, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

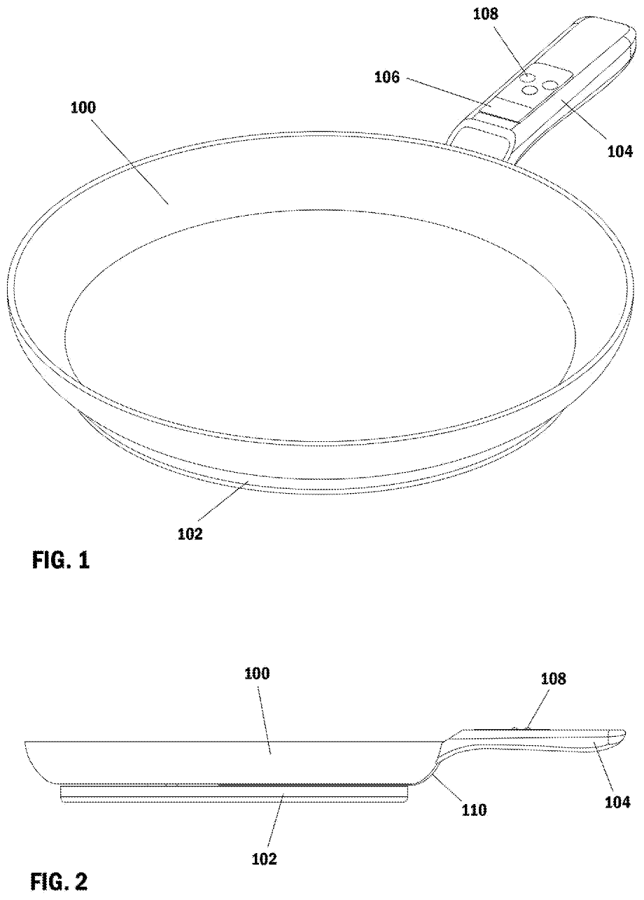

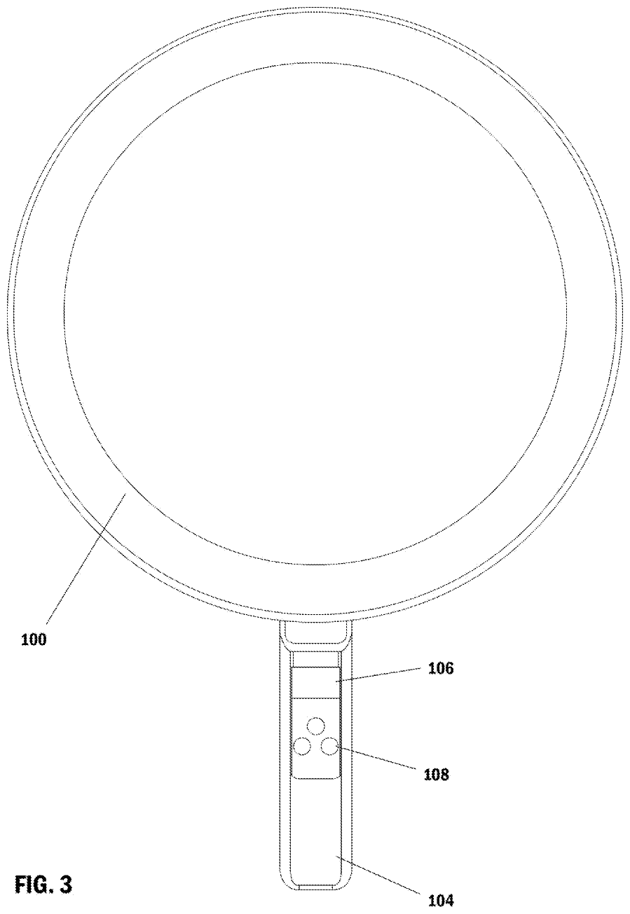

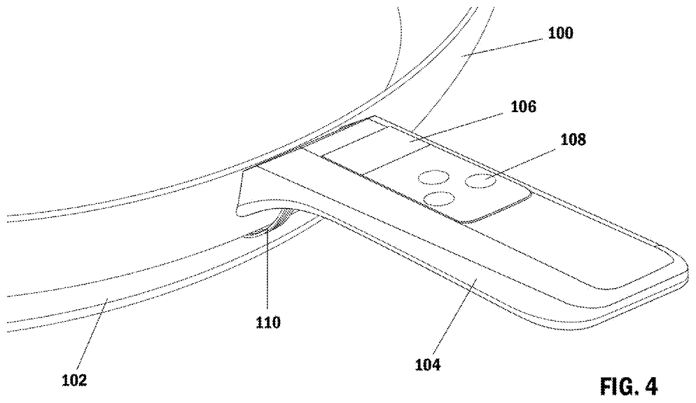

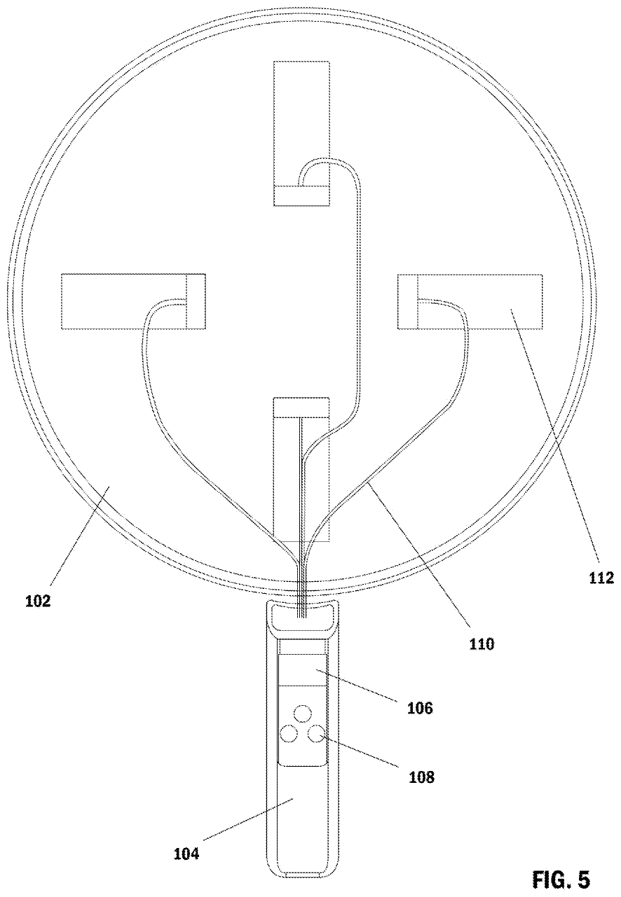

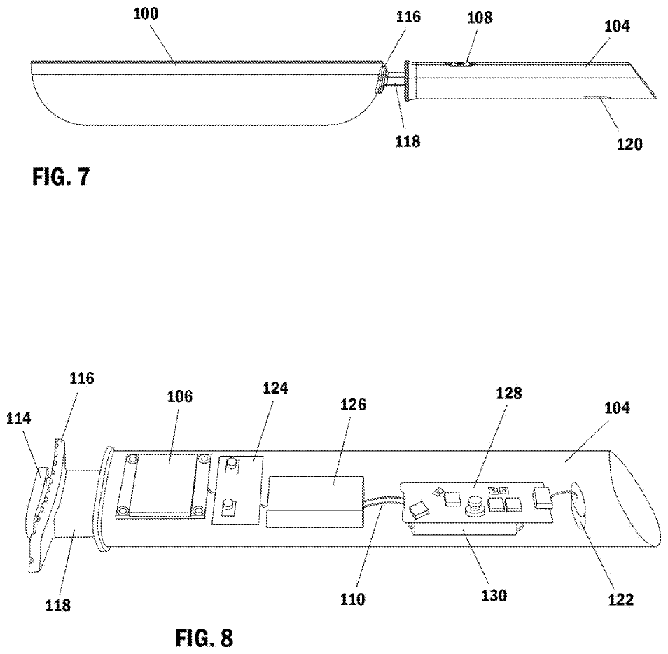

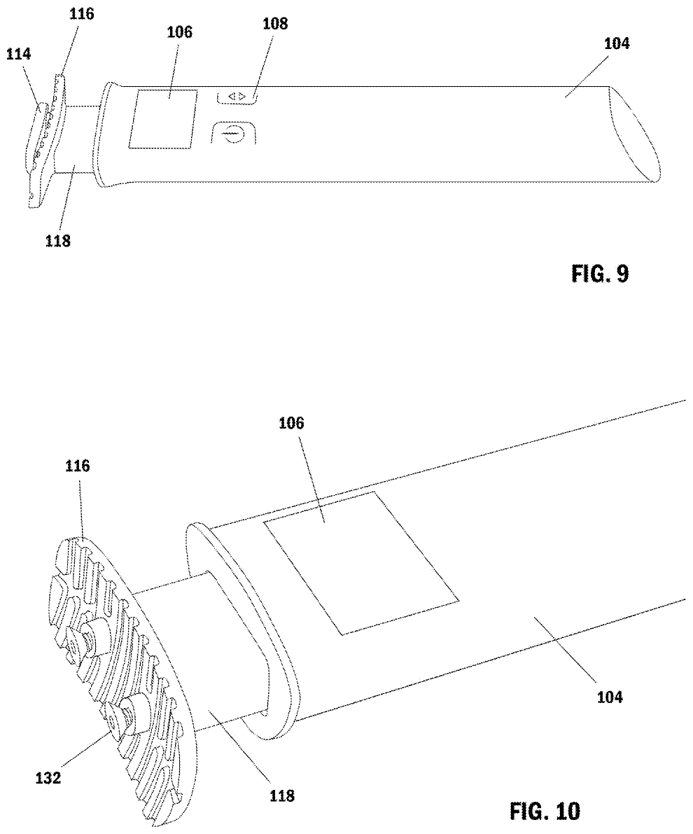

The illustrations of FIGS. 1-10 illustrate a multi-sensor interactive cooking device, as contemplated by the present disclosure. In one embodiment the device may comprise a cooking device, such as a pan or pot, integrating a plurality of sensors, a visual display, and an electronic interface. The device may have sensors for measuring, for example, food weight, food temperature, and food volume. The various sensors may be installed within or on the device as appropriate to the form factor of the particular cooking device. By way of example, a cooking device with a longer handle may have a plurality of sensors installed within the carrying handle. A device having shorter handles may have the plurality of sensors installed within its base. The multi-sensor interactive cooking device may further integrate a wireless connectivity and a proprietary software for additional functionality.

The illustrations of FIGS. 1-5 illustrate a first embodiment of a multi-sensor interactive cooking device, as contemplated by the present disclosure. The device may comprise, generally, a cooking area 100, a sensor base 102, and a sensor handle 104. The cooking area 100 may be any cooking area appropriate to a cooking device, and may vary in its diameter and the flare and height of its sides as desired. By way of example, in an embodiment wherein the multi-sensor interactive cooking device comprises a pan, the diameter of the base may be approximately ten (10) inches and the sides may be flared and approximately two (2) inches tall. In an embodiment wherein the multi-sensor interactive cooking device comprises a pot, the diameter of the base may be approximately twelve (12) inches and the sides may be straight and approximately twelve (12) inches tall.

The sensor base 102 may comprise a substantially disc-shaped component having a diameter similar to the diameter of the cooking area 100 of the given embodiment. A top surface of the sensor base 102 may be physically attached to a bottom surface of the cooking area 102, and a plurality of sensors 112 of the multi-sensor interactive cooking device may be installed within the sensor base 102. In one embodiment the plurality of sensors 112 may be attached to the top surface of the sensor base 102 and sandwiched between the top surface of the sensor base 102 and the bottom surface of the cooking area 100. In any embodiment the sensor base 102 may further comprise a material of construction suitable for conducting heat from a heat source, which may heat up a bottom surface of the sensor base 102, to the cooking area 100, while also comprising a material of construction suitable for protecting the plurality of sensors 112 from heat damage and fire damage.

The sensor handle 104 may be any handle appropriate to a cooking device, and may vary in its size, shape, and length as desired. By way of example, in an embodiment wherein the multi-sensor interactive cooking device comprises a pan, the sensor handle 104 may be relatively longer and suitable for actively handling the cooking device while cooking. In an embodiment wherein the multi-sensor interactive cooking device comprises a pot, the sensor handle 104 may comprise two loops or rounded handles suitable for lifting and tilting the cooking device.

The multi-sensor interactive cooking device may further comprise a visual display 106 and an input device 108. The visual display 106 may be any appropriate display such as, for example, a light-emitting diode (LED) screen or liquid crystal display (LCD) screen. The visual display 106 may be physically attached to the multi-sensor interactive cooking device, and may be electronically attached to the plurality of sensors 112 such that it may display a plurality of data outputs from the plurality of sensors 112. In one embodiment the visual display 106 may be installed within the sensor handle 104 such that the displayed information is visible to a user of the device. In an embodiment wherein the visual display 106 may not fit into the sensor handle 104, the visual display 106 may be installed within an external housing physically attached to an outer surface of the device and such that the displayed information is visible to a user of the device.

The input device 108 may comprise any input device appropriate for allowing a user to interact with and control the various functions of the multi-sensor interactive cooking device. In one embodiment the input device 108 may comprise a plurality of buttons that may allow a user to reversibly power on the electronic components of the device and change the display settings of the visual display 106. Such display settings may include, for example, the use of imperial or metric units or the selection of outputs from a different one of the plurality of sensors 112. The input device 108 may vary in size, shape, and number, as appropriate, to allow a user to control any features of the particular embodiment of the multi-sensor interactive cooking device.

The various electronic components of the multi-sensor interactive cooking device may be electrically connected to one another by a plurality of wiring 110, which may comprise any wiring suitable for such electrical signal conductivity. The plurality of wiring 110 may further comprise a material of construction that is heat resistant and flame resistant so as to reduce the likelihood of damage to the plurality of wiring 110 and the electronic components of the device.

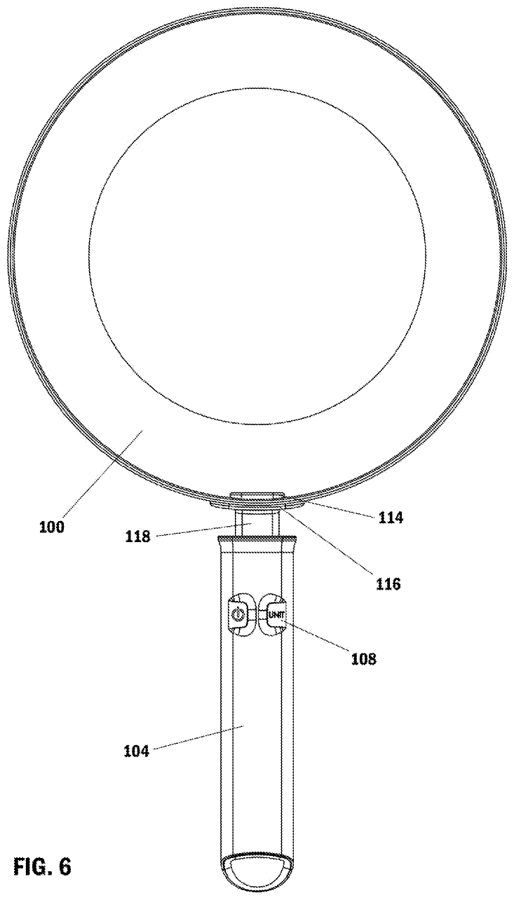

The illustrations of FIGS. 6-10 illustrate a second embodiment of a multi-sensor interactive cooking device, as contemplated by the present disclosure. The device may comprise, generally, a cooking area 100 and a sensor handle 104. The cooking area 100 may be any cooking area appropriate to a cooking device, and may vary in its diameter and the flare and height of its sides as desired. The sensor handle 104 may be any handle appropriate to a cooking device, and may vary in its size, shape, and length as desired, and may contain the visual display 106, the input device 108, and the plurality of sensors 112 within it. In any embodiment the sensor handle 104 may further comprise a material of construction suitable for protecting the various electronic components of the device from heat damage and fire damage.

In one embodiment the sensor handle 104 may comprise a skeletal structure having a cover and containing the plurality of electronic components of the multi-sensor interactive cooking device within it. The sensor handle 104 may be attached to the cooking area 100 via the combination of a handle mount 114 installed on an inner wall of the cooking area 100, a heat sink 116 installed on an outer wall of the cooking area 100, and the binding of these two components by the use of a plurality of mounting hardware 132 passing through both components and through a wall of the cooking area 100 sandwiched between them. The handle mount 114 and the heat sink 116 may comprise any size, shape, and thickness appropriate to the providing of sufficient structural rigidity to the connection between the sensor handle 104 and the cooking area 100.

The heat sink 116 may further comprise any size, shape, and thickness appropriate to the reducing of heat transfer between the cooking area 100 and the sensor handle 104. By way of example, the heat sink 116 may comprise a plurality of fins or trenches that reduce the effective contact area between the heat sink 116 and the outer surface of the cooking area 100. In this way the amount of surface area over which heat may be transmitted from the cooking area 100 to the sensor handle 104 is reduced and additional heat resistance is provided to the sensor handle 104 to protect the electronic components of the device. The heat sink 116 may be connected to the skeletal structure of the sensor handle 104 by a handle bridge 118, which may provide additional heat resistance to the sensor handle 104 by placing the electronic components of the device even further away from the cooking area 100.

The electronic components of the device may comprise, generally, the visual display 106, the input device 108, the plurality of wiring 110, and the plurality of sensors 112. The input device 108 may further comprise an input board 124 which may be positioned within the sensor handle 104 internally to a plurality of buttons attached to an outer covering over the sensor handle 104. The input board 124 may comprise a plurality of electronic switches or buttons activated by a user interacting with the plurality of buttons on the sensor handle 104 outer covering. The input board 124 may be electrically connected to the visual display 106 and may alter the display output as desired by the user.

The plurality of sensors 112 may further comprise a load cell 126, which may be any sensor appropriate for measuring a desired data point within the device. By way of example, the load cell 126 may be a torque-measuring device that may measure the weight of food in the cooking area 100 by the amount of torque exerted by the additional weight on a torque sensor installed in the handle bridge 118. By way of another example, the load cell 126 may be a pressure-measuring device that may measure the weight of food in the cooking area 100 by the amount of compression force exerted by the additional weight on a pressure sensor installed in the cooking area 100 itself. In one embodiment the load cell 126 may measure weight, temperature, volume, or any other appropriate measure.

The electronic components of the device may further comprise a microcontroller 128, which may be a central component within the device for controlling the various electronic features of the multi-sensor interactive cooking device. The microcontroller 128 may be electrically connected to the plurality of electronic components via the plurality of wiring 110, and may receive inputs from the plurality of sensors 112, receive inputs from the input device 108, send command outputs to the plurality of sensors 112, send command outputs to the visual display 106, or perform any other appropriate electronic function.

The electronic components of the device may further comprise a universal serial bus (USB) port 122, which may be used to interact with the multi-sensor interactive cooking device or to charge a power supply 130 of the device. The USB port 122 may be installed within the sensor handle 104 with its input port accessible from outside of the sensor handle 104. To protect the USB port from heat and flame damage the cover of the sensor handle 104 may comprise a USB port cover 120, which may be a hinge or flap that may be reversibly opened so that a user can access the USB port 122.

The electronic components of the device may further comprise a plurality of LED lights attached to the multi-sensor interactive cooking device such that they are visible to a user and usable as indicators of various parameters. By way of example, a single LED light may be used to indicate that the device is powered on, while another LED light may be used to indicate that a certain weight or temperature threshold has been achieved or exceeded.

The power supply 130 of the multi-sensor interactive cooking device may be any appropriate rechargeable or replaceable onboard battery or may be any appropriate plug-in connection that supplies power to the system.

The multi-sensor interactive cooking device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the multi-sensor interactive cooking device may be substantially constructed of one or more materials of plastic, acrylic, ceramic, polycarbonate, steel, aluminum, brass, fiberglass, carbon fiber, or combinations thereof. In some embodiments the various components of the system may be coated, lined, or otherwise insulated to prevent contamination. In one embodiment the material of construction may vary from one component to the next within the system.

In one embodiment the multi-sensor interactive cooking device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

In one embodiment the multi-sensor interactive cooking device may further comprise a computing system 200 that may perform as a server node for the device, and which may integrate wireless connectivity permitting the device to communicate with a central server or remote server node to effect the purpose of the cooking device. The wireless connectivity may allow communication via radio signal, digital signal, or any other appropriate means.

In one embodiment the multi-sensor interactive cooking device may further comprise a proprietary software, which may be used to operate the device. The proprietary software may further comprise a downloadable mobile application, which may allow a user to control the device and its various functions, display outputs from the plurality of sensors 112 of the device, or track outputs from the plurality of sensors 112 over time.

The proprietary software may further comprise a user account system. To protect the various user accounts, user data, and transactions stored within the system it is contemplated that the proprietary software may implement modern data security and encryption protocols. By way of example, the proprietary software may implement the advanced encryption standard (AES), the triple data encryption standard (3DES), the twofish standard, the Rivest, Shamir, Adelman standard (RSA), or any other appropriate encryption protocol. It is contemplated that the proprietary software may implement, at least, 128-bit encryption, though more difficult encryption, such as, for example, 206-bit or 256-bit, may be implemented as desired.

Inputs to the multi-sensor interactive cooking device user interface may be made by any appropriate means such as, for example, text-based input or voice-based input. In an embodiment comprising text-based input, the user may type queries and commands into the user interface using any appropriate input source, such as the input device 108 or a physical or virtual keyboard on a smartphone or tablet device connected to the system, whether physically or wirelessly. In an embodiment comprising voice-based input the user may interact with the system using a microphone, whether individually or integrated into a smartphone or tablet device, and the system may comprise speech recognition and language interpretation components to understand and interpret the input.

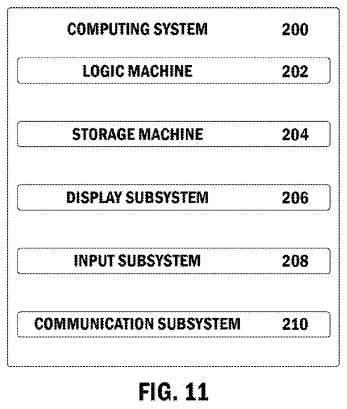

The illustration of FIG. 11 schematically presents a computing system configured to carry out and actualize methods and tasks described herein. In some embodiments the method is executed on a computing system such as computing system 200. For example, storage machine 204 may hold instructions executable by logic machine 202 to provide the method to users.

Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above.

The described method may be executed, provided, or implemented to a user on one or more computing devices via a computer-program product such as via an application programming interface (API). Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210.

Logic machine 202 may execute machine-readable instructions via one or more physical devices. For example, the logic machine 202 may be configured to execute instructions to perform tasks for a computer program. The logic machine may include one or more processors to execute machine-readable instructions.

Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices.

Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A multi-sensor interactive cooking device, comprising:
a cooking area;
a sensor handle;
a plurality of sensors;
a visual display;
an input device; and
a power supply;
wherein said sensor handle is attached to said cooking area;
wherein said plurality of sensors take a plurality of measurements of objects within said cooking area; and
wherein said plurality of sensors output said plurality of measurements of objects within said cooking area on said visual display.

2. The invention of claim 1,
wherein said plurality of sensors, said visual display, said input device, and said power supply are installed within said sensor handle.

3. The invention of claim 2, further comprising:
a universal serial bus (USB) port;
wherein said USB port is installed within said sensor handle.

4. The invention of claim 3, further comprising:
a computing device.

5. The invention of claim 4, further comprising:
a proprietary software.

6. The invention of claim 5, further comprising:
a wireless connectivity.

7. The invention of claim 6,
wherein one of said plurality of sensors comprises a weight sensor.

8. The invention of claim 7,
wherein one of said plurality of sensors comprises a temperature sensor.

9. The invention of claim 8,
wherein one of said plurality of sensors comprises a volume sensor.

10. The invention of claim 9, further comprising:
a plurality of LED lights.

11. A multi-sensor interactive cooking device, comprising:
a cooking area;
a sensor base;
a sensor handle;
a plurality of sensors;
a visual display;
an input device; and
a power supply;
wherein said sensor handle is attached to said cooking area;
wherein said plurality of sensors take a plurality of measurements of objects within said cooking area; and
wherein said plurality of sensors output said plurality of measurements of objects within said cooking area on said visual display.

12. The invention of claim 11,
wherein said visual display, said input device, and said power supply are installed within said sensor handle; and
wherein said plurality of sensors are installed within said sensor base.

13. The invention of claim 12, further comprising:
a universal serial bus (USB) port;
wherein said USB port is installed within said sensor handle.

14. The invention of claim 13, further comprising:
a computing device.

15. The invention of claim 14, further comprising:
a proprietary software.

16. The invention of claim 15, further comprising:
a wireless connectivity.

17. The invention of claim 16,
wherein one of said plurality of sensors comprises a weight sensor.

18. The invention of claim 17,
wherein one of said plurality of sensors comprises a temperature sensor.

19. The invention of claim 18,
wherein one of said plurality of sensors comprises a volume sensor.

20. The invention of claim 19, further comprising:
a plurality of LED lights.
